(19) United States
(12) Patent Application Publication
(10) Pub. No.: US 2023/0133993 A1
(43) Pub. Date: May 4, 2023

(54) EMBEDDED OPTICAL FILTER AND ANTI-REFLECTION IMPLEMENTATION WITH METAMATERIALS

(71) Applicant: TEXAS INSTRUMENTS INCORPORATED, Dallas, TX (US)

(72) Inventors: Hassan Omar ALI, Murphy, TX (US); Benjamin Stassen COOK, Addison, TX (US); Scott Robert SUMMERFELT, Garland, TX (US); Jo BITO, Dallas, TX (US)

(21) Appl. No.: 17/515,296

(22) Filed: Oct. 29, 2021

(51) Int. Cl. G02B 5/18; G02B 1/00; G02B 1/11; G02B 5/20; G01N 21/59; G01N 21/61

(52) U.S. Cl. CPC G02B 5/1819; G01N 21/61; G01N 21/5907; G02B 1/002; G02B 1/11; G02B 5/208

(57) ABSTRACT

An optical device includes a metamaterial layer configured to absorb a portion of an incident light having a frequency spectrum, the portion of the incident light having a frequency range that is narrower than and within the frequency spectrum of the incident light, a photodiode disposed in a layer coupled to the metamaterial layer and configured to detect an amplitude of the portion of the incident light, and shallow trench isolation (STI) structures disposed between the metamaterial layer and the photodiode, the STI structures configured to pass the portion of the incident light within the frequency range from the metamaterial layer to the photodiode.

### BACKGROUND

A metamaterial is an artificially made material that includes structures of geometric patterns having sub-wavelength dimensions with respect to a targeted electromagnetic spectrum or wavelength. The metamaterial is composed of one or multiple actual materials, such as a combination of metallic and dielectric materials. The subwavelength-scaled structures are distributed on or under the surface layer and can be disposed in one or more layers. The structures may have similar or different geometries and may be repeated and spaced across a layer to alter the behavior of electromagnetic waves, thereby causing an electromagnetic effect. For example, the structures may be separated round or square metal patches that are placed on a dielectric layer, or may be round or square gaps in a metal layer. A metamaterial can be designed to interact with an electromagnetic wave in a certain light spectrum, such as visible or infrared light, to absorb or reflect light at a certain wavelength or frequency.

### SUMMARY

In accordance with at least one example of the description, an apparatus includes a base layer including a photodiode, shallow trench isolation (STI) structures on the photodiode, and a metamaterial layer on the STI structures and including a metasurface and a dielectric layer.

In accordance with another example of the description, an optical device includes a metamaterial layer configured to absorb a portion of an incident light having a frequency spectrum, the portion of the incident light having a frequency range that is narrower than and within the frequency spectrum of the incident light, a photodiode disposed in a layer coupled to the metamaterial layer and configured to detect an amplitude of the portion of the incident light, and STI structures disposed between the metamaterial layer and the photodiode, the STI structures configured to pass the portion of the incident light within the frequency range from the metamaterial layer to the photodiode.

In accordance with another example of the description, a light detector system includes a light source configured to emit a light beam having a frequency spectrum, and a light detector configured to detect an amplitude of the light beam at the frequency spectrum. The light detector includes a base layer including a photodiode and STI structures on the photodiode, and a metamaterial layer on the STI structures and including a metasurface and a dielectric layer.

### BRIEF DESCRIPTION OF THE DRAWINGS

FIG. 1 is a block diagram of a light detector system, in accordance with various examples.

FIG. 2 is a block diagram of an optical device, in accordance with various examples.

FIG. 3 is a diagram of a metamaterial design, in accordance with various examples.

FIG. 4 is a diagram of a metasurface design, in accordance with various examples.

FIG. 5 is a diagram of a metasurface design, in accordance with various examples.

FIG. 6 is a diagram of an optical device design, in accordance with various examples.

FIG. 7 is a graph showing transmittance of a mold layer design, in accordance with various examples.

FIG. 8 is a graph showing absorptance of a metamaterial design, in accordance with various examples.

FIG. 9 is a diagram of another metamaterial design, in accordance with various examples.

FIG. 10 is a graph showing absorptance of different metamaterial designs, in accordance with various examples.

FIGS. 11A-11B are block diagrams of an optical device with one or more metamaterial layers, in accordance with various examples.

FIG. 12 is a flowchart of a method for light detection by an optical device including a metamaterial and STI structures on a photodiode layer, in accordance with various examples.

FIG. 13 is a block diagram of a hardware architecture for processing signal data, in accordance with various examples.

### DETAILED DESCRIPTION

Optical or light detectors, which may also be referred to as optical sensors, are types of devices that detect light at a specific frequency or light wavelength range. The detection includes absorbing a portion of incident light and converting it into a signal, such as an electrical signal, which can be measured and analyzed. Analysis of the measured electrical signal is useful to infer the characteristics of a sample exposed to the light. The collected signal data is useful to infer characteristics of the sample, such as the type, composition or density of materials in the sample. For example, optical detectors can serve as gas or fluid detectors in conjunction with various light sources and frequency spectrum, such as infrared, visible light or ultraviolet laser sources. Optical detectors may include various materials and layers designed for specific detection applications.

The possibility of designing metamaterials to control light and the manufacturing processes involved in manufacturing such structures may render metamaterials suitable for making optical devices. An optical detector may include a metamaterial engineered according to the optical device application. This may involve the metamaterial selecting or filtering a certain wavelength or range of wavelengths of incident light toward the detector and reflecting other wavelengths away from the detector. Metamaterial design includes determining the number of geometric patterns of the metamaterial structures, and the size and spacing of the geometric patterns at each layer, which can be arranged into stacked two-dimensional (2D) arrays. To achieve detection, the metamaterial may be combined with active devices, such as photodiodes on a substrate, which may be a silicon or other form of substrate.

The metamaterial may also be combined with other materials and layers that may be stacked to achieve increased light absorption at designed wavelengths. For example, dielectric layers may be overlaid on the metamaterial to form an anti-reflection coating (ARC) that may increase the absorption of light. The thickness and materials of the ARC can be selected to increase light absorption around the same wavelengths of light absorption of the metamaterial. The ARC may also be disposed between the metamaterial and the photodiodes. However, adding ARC layers to the optical detector device can present difficulties in the manufacturing process. The deposition of dielectric layers may involve different and additional manufacturing processes, which may add manufacturing cost and time. Also, such ARC implementation can be sensitive to variations in the manufacturing process, where variations of layer thickness, while within a manufacturing margin of error, can result in degradation in light absorption of the optical detector.

This description provides various examples of combining one or more metamaterial layers with photodiodes to achieve increased light filtering and absorption for optical detectors. The absorption can be increased by adding STI structures between the metamaterial layers and the photodiodes. The STI structures may provide isolation between adjacent photodiodes to mitigate electric current leakage. The STI structures may also form an ARC layer providing increased absorption of light from the metamaterial layers into the photodiodes. The STI structures can be added to the optical device via the same manufacturing process as other components of the optical device, and may be less sensitive to manufacturing variations and errors than other ARC solutions.

Light filtering and absorption can be further increased by adding a mold compound or layer on the metamaterial layers during a packaging process of the optical device. The mold compound can be designed to let light wavelengths covering or matching the filter range of the metamaterial through the optical detector and reject wavelengths outside that range. For example, for ambient or visible light optical detectors, the metamaterial may be designed to achieve light absorption in the visible spectrum and the mold compound may be designed to reject infrared light. Accordingly, the absorbed visible light may reach the photodiodes with reduced infrared radiation.

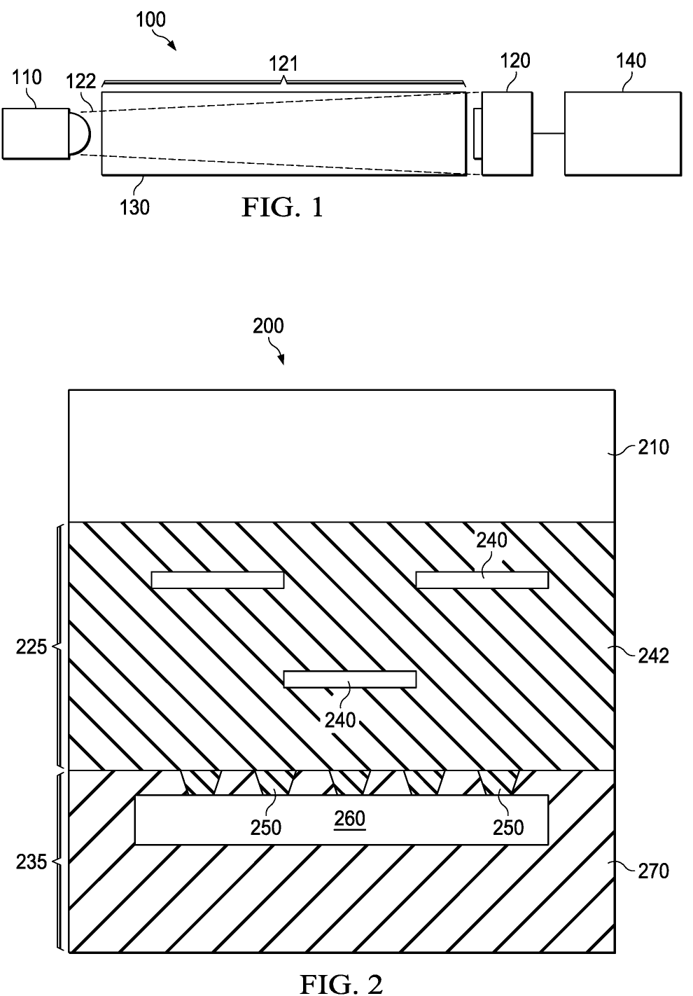

FIG. 1 is a block diagram of a light detector system 100, in accordance with various examples. The light detector system 100 may include a light source 110 and a light detector 120 separated by a space 121. The light source 110 may be any device or object that emits or reflects light 122 directed toward the light detector 120. For example, the light source 110 may be a physical object providing light in the visible spectrum or the infrared spectrum. The light detector 120 may be positioned in front of the light source 110 to detect at least a portion of the emitted light that is incident on the surface of the light detector 120. The light detector 120 may be designed to absorb the light within a wavelength or frequency range, which falls in the light spectrum of the light source 110. The intensity or amplitude of the absorbed light may be detected via photodiodes in the light detector 120. The photodiodes and other components of the light detector 120 may be encased in a package to protect the light detector 120.

FIG. 2 shows a cross section view of an optical device 200, in accordance with various examples. The optical device 200 may be a light sensing device capable of absorbing incident light and detecting the intensity or amplitude of the absorbed light. For example, the optical device 200 may be part of the light detector 120 and may produce an electrical signal responsive to absorbing the incident light. The optical device 200 may include multiple layers and materials designed to increase the absorbed amount or portion of the incident light. Increasing the amount of absorbed and detected light may increase the signal-to-noise ratio in a light detection system and hence allow for more accurate detection results. The optical device 200 may include mold layer 210, a metamaterial 225 on a base layer 235.

The metamaterial 225 may include one or more metasurfaces 240 embedded in one or more dielectric layers 242 of the metamaterial 225. Each metasurface 240 may form a layer of one-dimensional (1D) or two-dimensional (2D) arrays of structures disposed across the same layer. For example, the metasurface 240 may include a grid of metal patches equally spaced in the dielectric layer 242. The structures of the multiple metasurfaces 240 may have patterns of different geometries, sizes, and spacing. The spacing of the structures may determine the filtering and ARC properties of the metasurface 240 and accordingly the metamaterial 225. The metal patches may have various geometries, such as square, round, slit, or cross patterns. In another example, the metasurface 240 may include a grid of equally spaced gaps in a metal sheet or layer. The gaps may be empty space, may be filled with a dielectric or other material, or a combination thereof.

The base layer 235 may include STI structures 250 disposed on a photodiode layer 260. The STI structures 250 and the photodiode layer 260 may be embedded in one or more semiconductor layers 270 of the base layer 235. The STI structures 250 may be trenches formed in the semiconductor layer 270 and filled with another material, which may be a dielectric. The photodiode layer 260 may include multiple photodiodes arranged in an array or grid. The STI structures 250 may be aligned on the photodiodes to cause isolation and prevent electric current leakage between the photodiodes. The photodiodes may absorb the light and convert the light energy into electrical energy in the form of a detected voltage or electrical signal. The metamaterial 225 may be positioned between the base layer 235 and the mold layer 210. The mold layer 210 may be a substantially transparent dielectric substrate that allows the incident light to pass through toward the metamaterial 225 and provide protection for the other layers.

To increase the absorption of incident light in the optical device 200 at a wavelength or frequency range, the metamaterial 225 may be designed for both filtering and ARC properties. The materials of the components of the metamaterial 225 and the spacing of the structures in the metasurfaces 240 may be designed to increase light filtering toward the photodiode layer 260 in a wavelength range, and to reflect light away from the photodiode layer 260 outside that wavelength range. The shape of the structures and/or the number of metasurfaces 240 and dielectric layers 242 in the metamaterial 225 may be designed to further increase light absorption and to narrow or widen the wavelength range. Increasing the light absorption property of the metamaterial 225 provides the ARC function, and designing the wavelength range for such absorption provides the filtering function of the metamaterial 225. The STI structures 250 may also be designed to match the ARC properties of the metamaterial 225. For example, the material, the size and/or the depth, which may also be referred to as the thickness, of the STI structures 250 may be designed to increase light filtering toward the photodiode layer 260 in the absorption wavelength range of the metamaterial 225. The mold layer 210 may also be designed to match the filtering and ARC properties of the metamaterial 225, such as based on the thickness and the material composition of the mold layer 210.

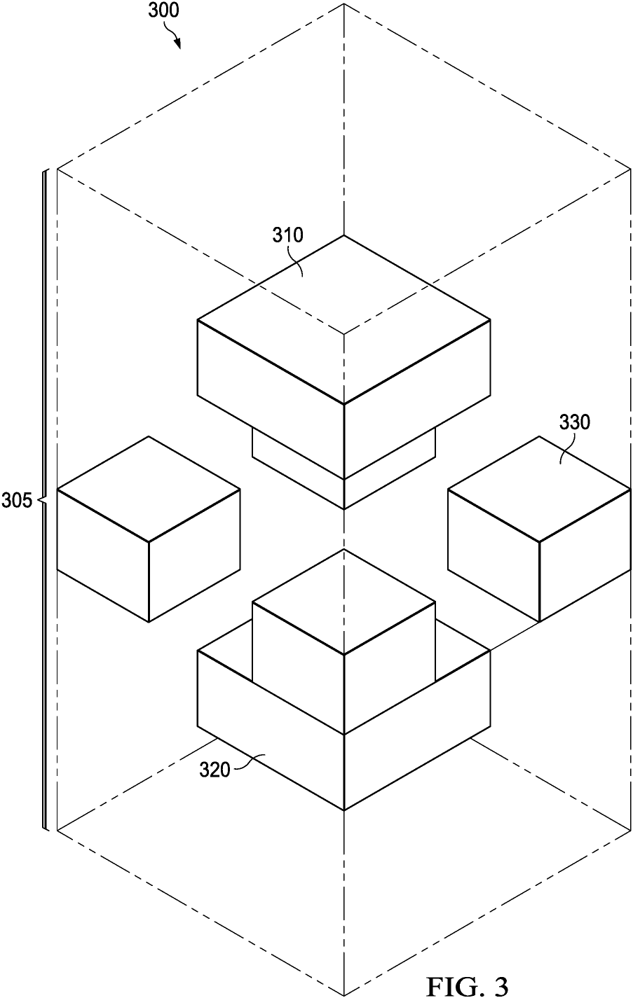

FIG. 3 shows a metamaterial design 300, in accordance with various examples. The metamaterial design 300 is useful for the metamaterial 225 of the optical device 200. The metamaterial design 300 includes three layers of metasurfaces that are stacked and embedded in one or more layers of dielectrics 305. Each of the metasurfaces includes repeated and equally spaced structures in a 2D array or grid formation in the respective layer. The metamaterial design 300 of FIG. 3 shows one unit of the grid that includes the repeated structure, though other numbers of units of the grid are possible. A first metasurface may include square metal patches 310, and a second metasurface in another layer of the metamaterial may include respective square metal patches 320. The materials and/or the dimensions of the square metal patches 310 in the first metasurface and the square metal patches 320 in the second metasurface may be different. In an example, a third metasurface positioned between the first and second metasurfaces may include four square metal patches 330 within the grid unit. In such an example, the square metal patches 330 may be smaller in width than the square metal patches 310 and 320. The square metal patches 310, 320, and 330 may also have different thicknesses.

As described above, the filtering and ARC properties of the metamaterial 225 may depend on the materials of the metamaterial 225 and the spacing of the structures in the grid, as well as on the dimensions of the structures. Therefore, the materials of the structures and the dielectrics, and the spacing of the structures, may be designed to select the wavelength range for light absorption. The structure dimensions, including the width and thickness of the structures, may be designed to tune the filtering and ARC properties of the metamaterial 225, based on the materials and spacing. For example, to achieve light absorption in the infrared spectrum within a narrower wavelength range in that spectrum, the spacing of the metal patches in a metasurface 240 may be about 100 micrometers (µm) and the metasurface 240 or structure thickness may be about 10 µm. In the case of light absorption in the visible spectrum, the spacing may be in the sub-micron region (< about 1 µm) and the thickness of the structure may be less than about 0.01 µm.

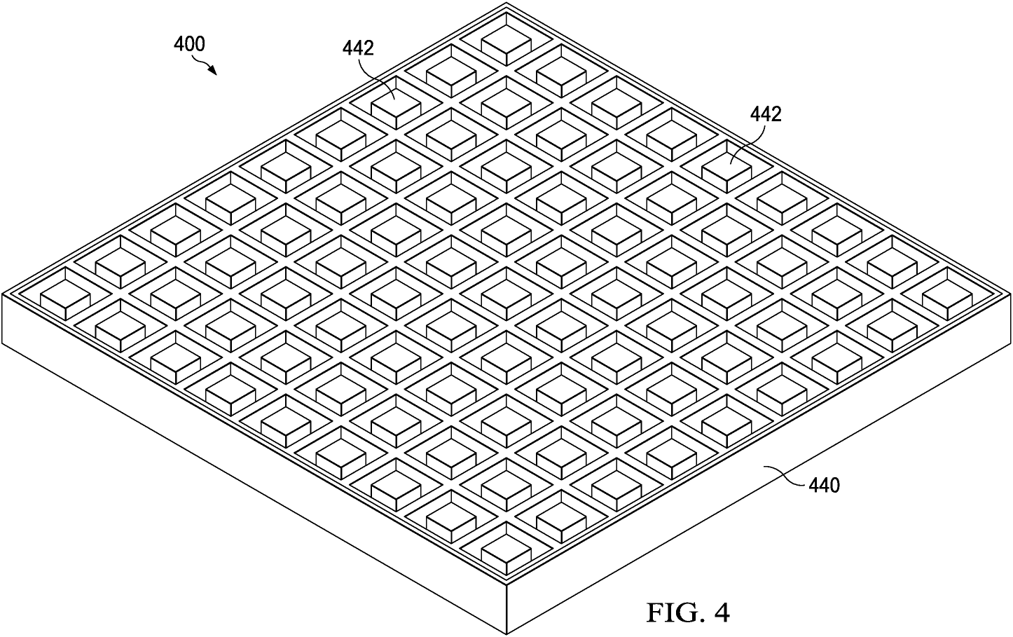

FIG. 4 shows a metasurface design 400, in accordance with various examples. The metasurface design 400 may be part of the metamaterial design 300 or be useful for the metasurface 240 of the optical device 200. The metasurface design 400 includes a metal grid 440. The metal grid 440 includes equally spaced square gaps, where each gap includes a square patch 442. The square patches 442 may be of a different material than the metal grid 440. For example, the square patches 442 may be formed of a dielectric material or another metal.

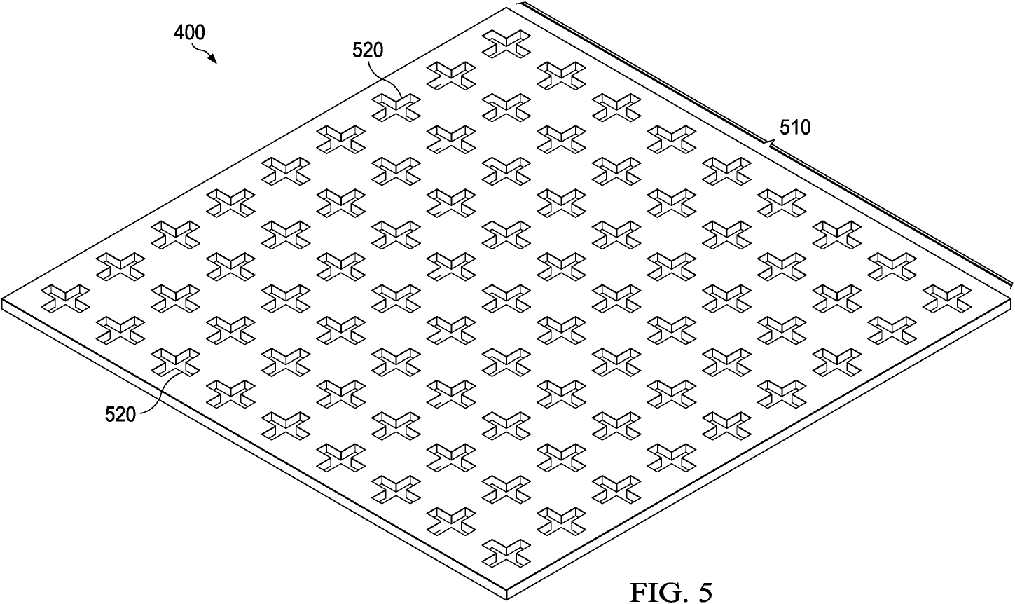

FIG. 5 shows a metasurface design 500, in accordance with various examples. The metasurface design 500 may be part of the metamaterial design 300 or be useful for the metasurface 240 of the optical device 200. For example, both the metasurface designs 400 and 500 may be part of the same metamaterial at different layers. The metasurface design 500 includes a metal mesh 510 with repeated and equally spaced cross patterns 520. The cross patterns 520 may be etched into a metal layer to form the metal mesh 510.

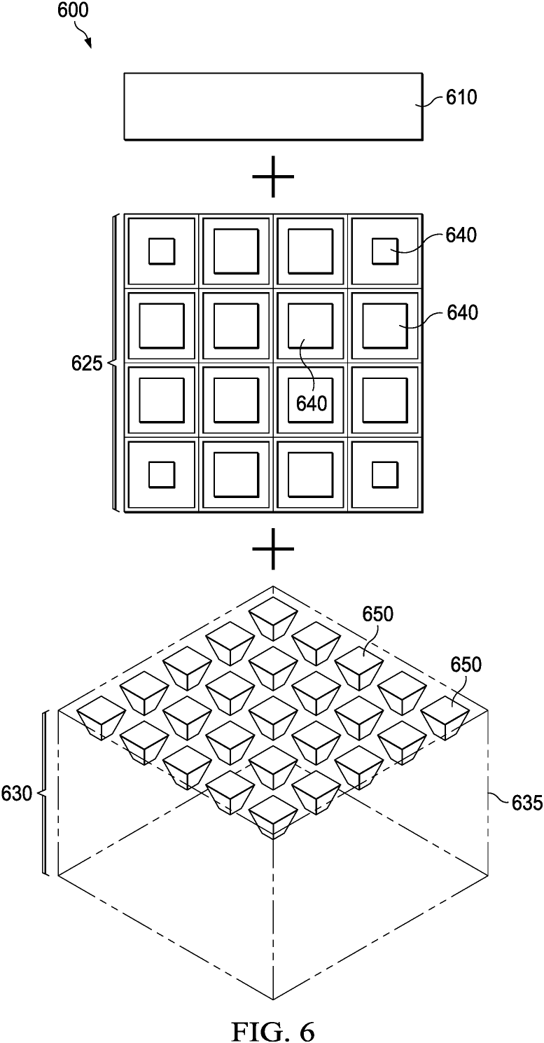

FIG. 6 shows an optical device design 600, in accordance with various examples. The optical device design 600 is useful for the optical device 200 to increase light absorption in a wavelength range within a spectrum of incident light. The optical device design 600 may be separated into separate design components, including a mold layer design 610, a metamaterial design 625 and a base layer design 630. Similar to the metamaterial design 300 above, the metamaterial design 625 is useful for the metamaterial 225 of the optical device 200. The metamaterial design 625 may include one or more layers of metasurfaces including structures 640 embedded in one or more layers of dielectrics (not shown). The materials of the structures 640 and the dielectrics, and the spacing of the structures 640, may be designed to provide a filter wavelength range for light absorption. The width and thickness of the structures 640 may be designed to tune the filtering and ARC properties of the metamaterial. Tuning the design of the structures 640 to narrow the filter wavelength range may increase the filtering provided by the metamaterial. Also, tuning the design to increase absorption in the filter wavelength range and increase reflection outside the filter wavelength range may increase the ARC effect of the metamaterial.

The base layer design 630 is useful for the base layer 235 of the optical device 200 to increase the ARC effect. The base layer design 630 includes STI structures 650 that may be arranged in a 2D array on a photodiode layer 630. The material, spacing, and thickness of the STI structures 650 may be designed to increase the filtering of light from the metamaterial to the photodiodes in the filter wavelength range of the metamaterial. The base layer design 630 may also include a dielectric layer material in which the photodiode layer 635 may be disposed. The mold layer design 610 is useful for the mold layer 210 of the optical device 200 to increase the filtering and ARC effects of the metamaterial. In some examples, the mold layer design 610 includes a thickness and material of the mold layer 210 on the metamaterial designed to increase light absorption within the filter wavelength range of the metamaterial design 625.

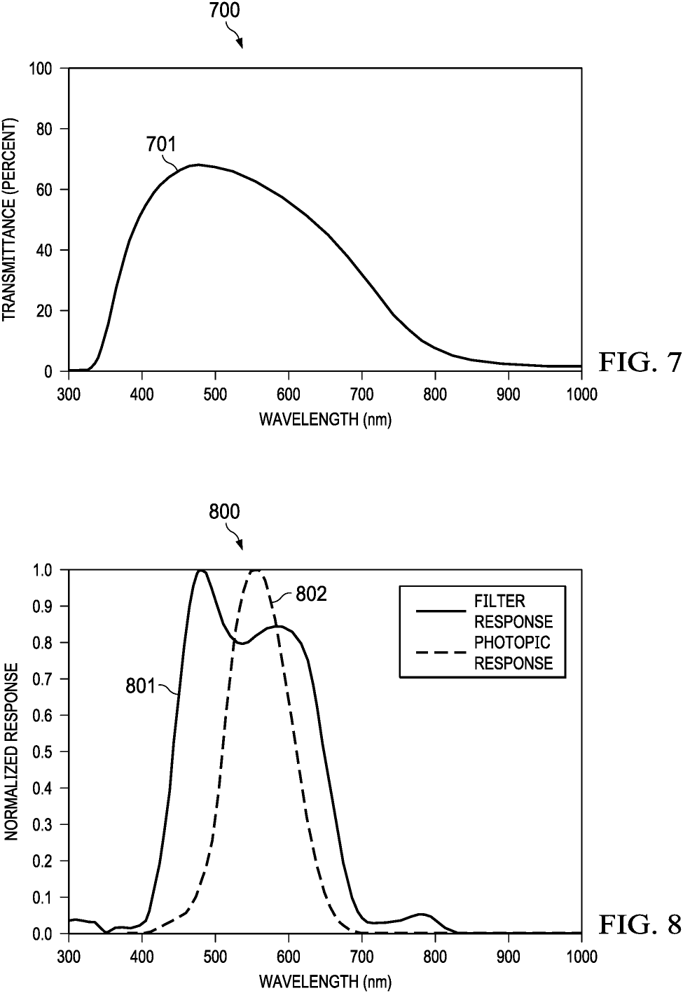

FIG. 7 is a graph showing transmittance 700 of a mold layer design, in which the x-axis represents a range of wavelengths of a transmitted light through a mold layer, and the y-axis represents the amplitude (in percent) of the transmitted light. The amplitude of the transmitted light may be referred to as transmittance. The wavelength range includes a range of wavelengths, from about 300 nanometers (nm) to about 1000 nm, which corresponds to the visible spectrum for the most part. The transmittance 700 characteristics such as those shown on curve 701 varies with the thickness of the mold layer. For example, the thickness of the mold layer may range from a fraction of a millimeter to a few millimeters. The mold layer may be formed of a dielectric such as glass or a similar material. The transmittance 700 data shows that the mold layer with the least thickness provides the highest transmittance at higher than 80 percent (%).

FIG. 8 is a graph showing light absorption 800 of a metamaterial design, in which the x-axis represents a range of wavelengths of absorbed light through a metamaterial, and the y-axis represents the amplitude (in percent) of the absorbed light. The amplitude of absorbed light is also referred to as a filter response. The wavelength range includes a range of wavelengths, from about 300 nm to about 1000 nm, which corresponds to the visible spectrum for the most part. The light absorption 800 data is reflected by a filter response curve 801 for absorbing light having a wavelength range from about 450 nm to about 650 nm. The filter response curve 801 shows a first peak at full absorption (e.g., at a normalized response equal to 1) at a wavelength of about 475 nm and a second peak at about 0.85 (or 85%) absorption at a wavelength of about 575 nm. The filter response curve 801 may overlap with a curve 802 representing an ideal photopic filter response that indicates the detection capability of a human eye. The filter response curve 801 corresponds to a metamaterial including one or multiple metasurfaces, as described herein. For example, the normalized response of the filter response curve 801 may be obtained for a metamaterial according to the metamaterial design 300. In this example, the width of the grid unit is about 300 nm. The width of a square metal patch 310 and similarly a square metal patch 320, within the grid unit, is about 150 nm, and the width of a square metal patch 330 is about 100 nm. The transmittance 700 of a mold layer design, as shown in FIG. 7, and the light absorption 800 of a metamaterial design show an overlap in the filtering and ARC properties of the mold layer design and metamaterial designs of FIGS. 7 and 8. The two designs may be combined into an optical device design for a light detector, such as in the optical device design 600 for the optical device 200.

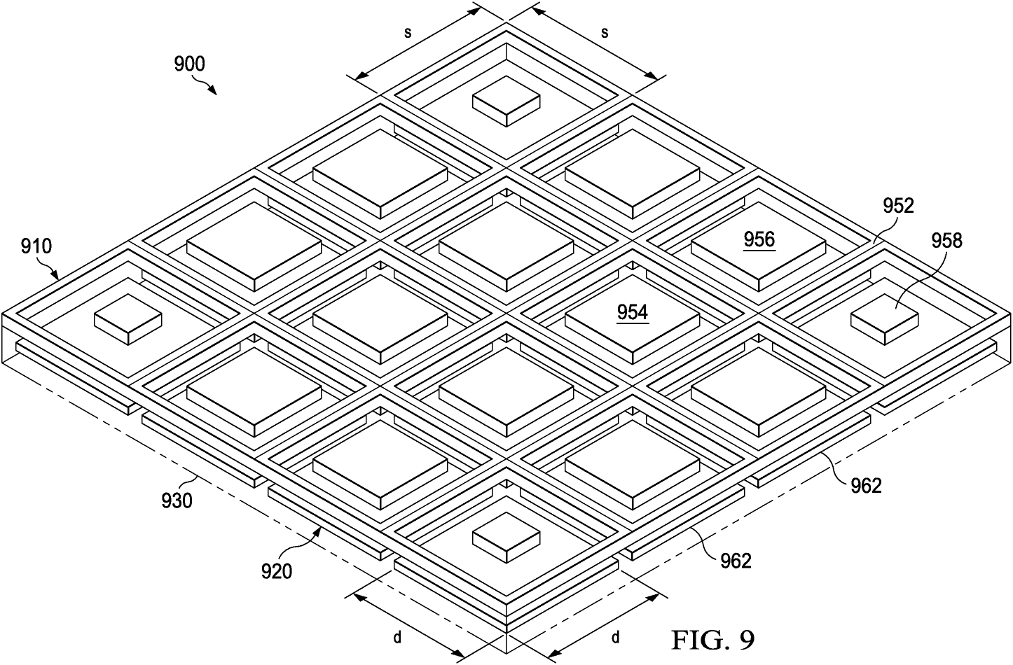

FIG. 9 shows another metamaterial design 900, in accordance with various examples. The metamaterial design 900 may also be useful for the metamaterial 225 of the optical device 200. The metamaterial design 900 includes a first metasurface 910 and a second metasurface 920 on a dielectric layer 930. Each of the first metasurface 910 and the second metasurface 920 may include repeated and spaced structures in a 2D array formation. The first metasurface 910 may be composed of a metal grid 952 with gaps filled by different metal patches. In an example, the metal patches include three different metal patches 954, 956, and 958 which may be repeated and spaced differently in the first metasurface 910. The metal patches 954, 956, and 958 may also have different widths or may be composed of different metal or materials. The second metasurface 920 may include a 2D array of uniform and equally spaced square metal patches 962. In one example, the metamaterial design 900 may be for filtering light in the infrared spectrum. Accordingly, the grid spacing (s) and the width (d) of the structures in the metasurfaces 910, 920 may be on the order of one or multiple micrometers.

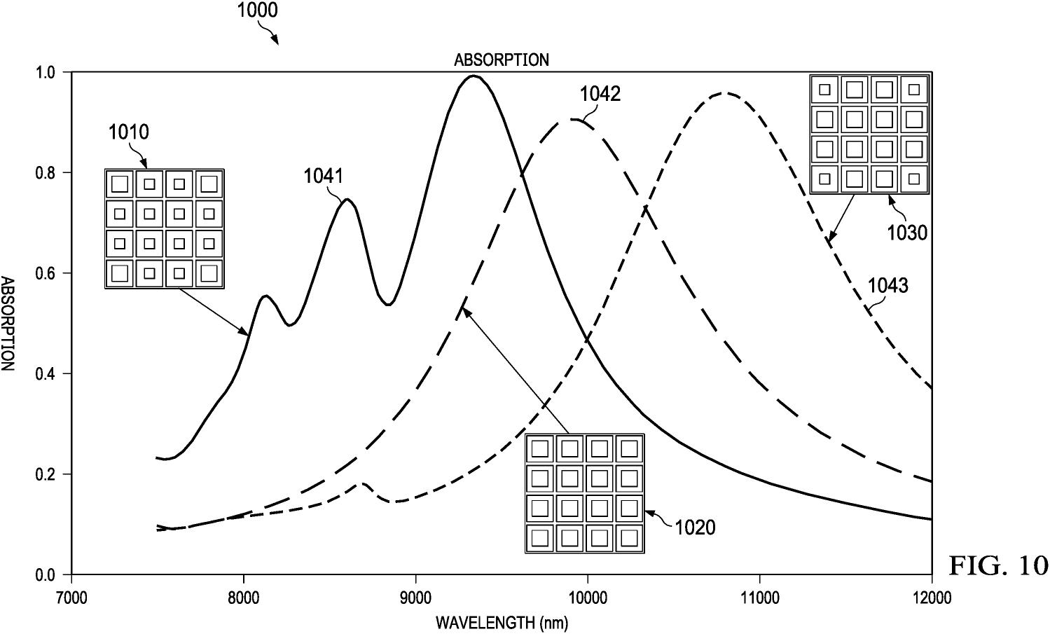

FIG. 10 shows light absorption 1000 from metamaterial designs 1010, 1020, and 1030, in which the x-axis represents a range of wavelengths of absorbed light, and the y-axis represents the amplitude (in percent) of the absorbed light. The light absorption data represents the normalized filtering response over the infrared wavelength range from about 7000 nm to about 12000 nm. The metamaterial designs 1010, 1020, and 1030 may be similar to the metamaterial design 900 but with varying structure dimensions. Accordingly, the metamaterial designs 1010, 1020, and 1030 have different filtering responses represented by the filter response curves 1041, 1042, and 1043, respectively. The filter response curves 1041, 1042, and 1043 show an absorption of higher than 0.4 (40%) in the wavelength range from about 8 µm to about 12 µm. In this example, the grid spacing of the structures in the metasurfaces of the metamaterial designs 1010, 1020, and 1030 is about 3.5 µm, and the width of the structures in the second metamaterial with uniform square patches, similar to the second metasurface 920, is about 3 µm. However, the widths of the different square patches in the first metasurface, similar to the first metasurface 910, vary in the metamaterial designs 1010, 1020, and 1030, which causes the variation of their filtering response as shown by the filter response curves 1041, 1042, and 1043. The resulting broad ARC response, as shown in the combination of filter response curves 1041, 1042, and 1043, may be achieved by combining metamaterial designs 1010, 1020, and 1030 or metasurfaces with different structure dimensions in the same layer of the device during the same manufacturing process or step.

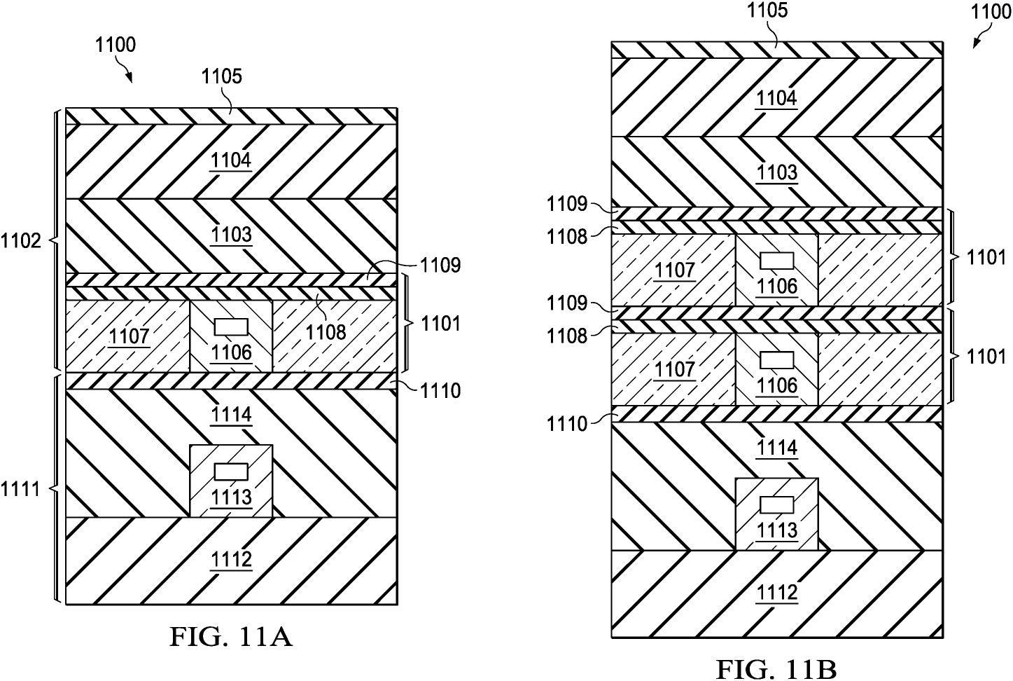

FIGS. 11A and 11B show a cross section view of an optical device 1100 including one or more metamaterial layers, in accordance with various examples. For example, the optical device 1100 may include one or more metamaterial layers 1101. FIG. 11A shows the optical device 1100 with one metamaterial layer 1101, which may be formed as part of a first manufacturing process 1102. FIG. 11B shows another example of the optical device 1100 with two stacked and similar metamaterial layers 1101, which may be formed by repeating the same steps of the manufacturing process 1102. The optical device 1100 may also include multiple layers formed according to the same manufacturing process 1102. The same process layers may include multiple dielectric layers stacked on the metamaterial layer 1101. For example, the dielectric layers include a polyethylene (PO) oxide layer 1103 disposed on the metamaterial layer 1101, a silicon oxynitride (SiON) layer 1104 disposed on the PO Oxide layer 1103, and a silicon nitride (SiN) layer 1105 disposed on the SiON layer 1104. The PO Oxide layer 1103 may have a similar thickness as the SiON layer 1104. In one example, the optical device 1100 may be designed for operation in the infrared spectrum. Accordingly, the thickness of the PO Oxide layer 1103 and the SiON layer 1104 may be about 400 nm with up to about 48 nm variation due to manufacturing processes. The SiN layer 1105 may be thinner at about 30 nm thickness with up to about 5 nm variation.

The metamaterial layer 1101 may include a metal patch 1106 embedded in an inter-metal dielectric layer of organosilicate glass (IMD OSG) 1107. The metamaterial layer 1101 may also include a silicon carbon nitride (SiCN) layer 1108 disposed on the IMD OSG 1107, and a silicon oxycarbide (SiCO) layer 1109 disposed on the SiCN layer 1108. The thickness of the metal patch 1106 and the IMD OSG 1107 may be about 140 nm with up to about 50 nm variation. The thickness of the SiCO layer 1109 and the SiCN layer 1108 may be about 40 nm with up to about 4 nm variation. The metamaterial layer 1101 may also be disposed on a second SiCO layer 1110 provided via the same manufacturing process 1102.

The manufacturing process 1102 that forms the layers described above (e.g., the first manufacturing process) may be a process capable of forming relatively thin layers with high accuracy. Such layers may be disposed on thicker layers of the optical device 1100. The thicker layers may be formed by a second less controlled or stringent manufacturing process 1111with less manufacturing accuracy and more thickness variation. The thicker layers may include an interlevel dielectric (ILD) layer 1112, and a thicker metal patch 1113 embedded in a thicker IMD layer 1114 on the ILD layer 1112. The thickness of the ILD layer 1112 may be about 600 nm with up to about 140 nm variation. The thickness of the metal patch 1113 may be about 613 nm with up to about 69 nm variation, and the thickness of the thicker IMD layer 1114 may be about 1113 nm with up to about 186 nm variation.

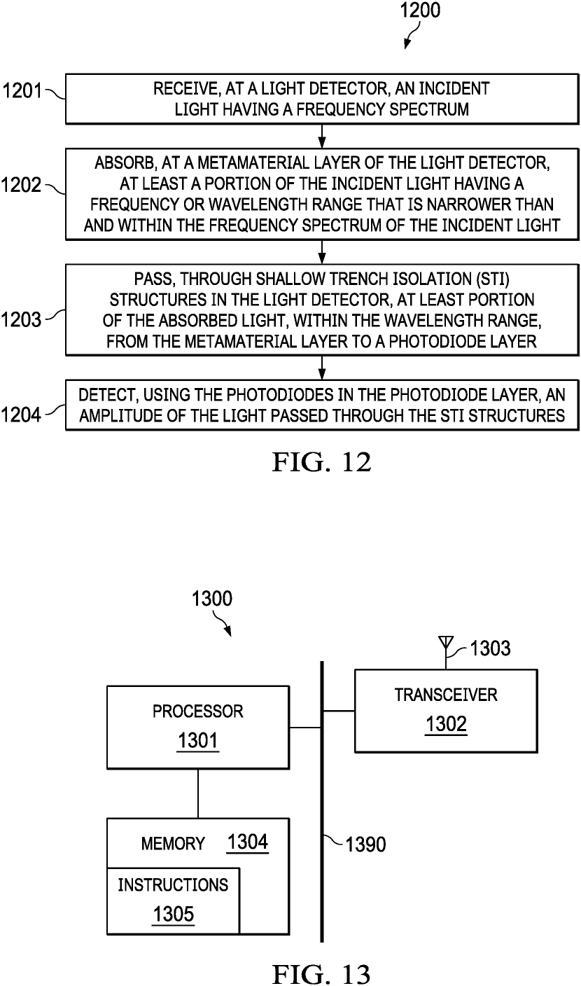

FIG. 12 is a flowchart of a method 1200 for light detection by an optical device, in accordance with various examples. The optical device may include a metamaterial and STI structures on a photodiode layer. For example, the method 1200 may be performed by a light detector such as the light detector 120 in the light detector system 100. The light detector may include an optical device such as the optical device 200, or another optical device designed in accordance with any of the optical designs described above. At step 1201, the light detector may receive an incident light having a frequency spectrum. The incident light may correspond to a light beam emitted from a laser or other light source. A sample, such as a fluid or gas, may be exposed to the light beam before reaching the optical detector. At step 1202, a metamaterial layer of the light detector may absorb at least a portion of the incident light at a frequency or wavelength range that is narrower than and within the frequency spectrum of the incident light. In another example, the light detector may include a mold layer disposed on the metamaterial. In this case, a portion of the incident light is first passed by the mold layer toward the metamaterial which then absorbs the received portion of light. At step 1203, the STI structures in the light detector pass at least a portion of the absorbed light from the metamaterial layer and within the same wavelength range to a photodiode layer. At step 1204, the amplitude of the light passed through the STI structures is detected via the photodiodes in the photodiode layer. The light detection may include the photodiodes converting the light energy into electrical energy which may be measured as a voltage or electrical signal and analyzed by a processing system to infer or determine characteristics of the sample.

FIG. 13 is a block diagram of a hardware architecture 1300 of a processing system, in accordance with various examples. The hardware architecture 1300 includes hardware components that may be part of the processing system. For example, the hardware architecture 1300 may correspond to the processing system 140 in the light detector system 100. As shown in FIG. 13, the hardware architecture 1300 may include one or more processors 1301, and one or more memories 1304. In some examples, the hardware architecture 1300 may also include one or more transceivers 1302, and one or more antennas 1303 for establishing wireless connections. These components may be connected through a bus 1390 or in any other suitable manner. In FIG. 13, an example in which the components are connected through a bus 1390 is shown.

The processor 1301 may be configured to read and execute computer-readable instructions. For example, the processor 1301 may be configured to invoke and execute instructions stored in the memory 1304, including the instructions 1305. The processor 1301 may support one or more global systems for wireless communication. Responsive to the processor 1301 sending a message or data, the processor 1301 drives or controls the transceiver 1302 to perform the sending. The processor 1301 also drives or controls the transceiver 1302 to perform receiving, responsive to the processor 1301 receiving a message or data. Therefore, the processor 1301 may be considered as a control center for performing sending or receiving, and the transceiver 1302 is an executor for performing the sending and receiving operations.

In an example, the memory 1304 may be coupled to the processor 1301 through the bus 1390 or an input/output port. In another example, the memory 1304 may be integrated with the processor 1301. The memory 1304 is configured to store various software programs and/or multiple groups of instructions, including instructions 1305. For example, the memory 1304 may include a high-speed random-access memory, and may further include a nonvolatile memory such as one or more disk storage devices, a flash memory, or another nonvolatile solid-state storage device. The memory 1304 may store an operating system such an operating system such as ANDROID, IOS, WINDOWS, or LINUX. The memory 1304 may further store a network communications program. The network communications program is useful for communication with one or more attached devices, one or more user equipments, or one or more network devices, for example. The memory 1304 may further store a user interface program. The user interface program may display content of an application through a graphical interface, and receive a control operation performed by a user on the application via an input control such as a menu, a dialog box, or a physical input device (not shown). The memory 1304 may be configured to store the instructions 1305 for implementing the various methods and processes provided in accordance with the various examples of this application.

The antenna 1303 may be configured to convert electromagnetic energy into an electromagnetic wave in free space, or convert an electromagnetic wave in free space into electromagnetic energy in a transmission line. The transceiver 1302 may be configured to transmit a signal that is provided by the processor 1301, or may be configured to receive a wireless communications signal received by the antenna 1303. In this example, the transceiver 1302 may be considered a wireless transceiver.

The hardware architecture 1300 may also include another communications component such as a Global Positioning System (GPS) module, a BLUETOOTH module, or a WI-FI module. The hardware architecture 1300 may also support another wireless communications signal such as a satellite signal or a short-wave signal. The hardware architecture 1300 may also be provided with a wired network interface or a local area network (LAN) interface to support wired communication.

In accordance with various examples, the hardware architecture 1300 may further include an input/output device (not shown), an audio input/output device, a key input device, a display, and the like. The input/output device may be configured to implement interaction between the hardware architecture 1300 and a user/an external environment, and may include the audio input/output device, the key input device, the display, and the like. The input/output device may further include a camera, a touchscreen, a sensor, and the like. The input/output device may communicate with the processor 1301 through a user interface.

It should be noted that the hardware architecture 1300 shown in FIG. 13 is a possible implementation in various examples of this application. During actual application, the hardware architecture 1300 may include more or fewer components. This is not limited herein.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through a construction and/or layout of hardware components and interconnections of the device, or a combination thereof.

A device that is described herein as including certain components may instead be adapted to be coupled to those components to form the described device. For example, a structure described as including one or more elements (such as structures or layers) and/or one or more sources (such as voltage and/or current sources) may instead include only the elements within a single physical device (e.g., the structures and layers in the device) and may be adapted to be coupled to at least some of the sources to form the described structure or system either at a time of manufacture or after a time of manufacture, for example, by an end-user and/or a third-party.

While certain components may be described herein as being of a particular process technology, these components may be exchanged for components of other process technologies. Structures and designs described herein are reconfigurable to include the replaced components to provide functionality at least partially similar to functionality available prior to the component replacement.

Unless otherwise stated, “about,” “approximately,” or “substantially” preceding a value means +/- 10 percent of the stated value. Modifications are possible in the described examples, and other examples are possible within the scope of the claims.

What is claimed is:

1. An apparatus, comprising:
a base layer comprising a photodiode;
shallow trench isolation (STI) structures on the photodiode; and
a metamaterial layer on the STI structures and comprising a metasurface and a dielectric layer.

2. The apparatus of claim 1, wherein the STI structures are embedded in the base layer, and the metamaterial layer is on the base layer.

3. The apparatus of claim 1, wherein the STI structures are equally spaced in an array that forms a grating, the grating is an anti-reflection coating (ARC) layer for a frequency spectrum of an incident light, and the grating is configured to allow a portion of the incident light to pass to the photodiode.

4. The apparatus of claim 1, wherein the metasurface is embedded in the dielectric layer of the metamaterial layer.

5. The apparatus of claim 1, wherein the metasurface includes an array of equally spaced structures, and the structures are metal patches or gaps in a metal layer of the metasurface.

6. The apparatus of claim 5, wherein a size and a spacing of the equally spaced structures are configured to absorb a portion of an incident light at a frequency range narrower than a frequency spectrum of the incident light.

7. The apparatus of claim 1, wherein the metamaterial layer includes two or more metasurfaces embedded in the dielectric layer.

8. The apparatus of claim 7, wherein the two or more metasurfaces include a first metasurface and a second metasurface having different numbers or sizes of equally spaced structures.

9. The apparatus of claim 1, further comprising a mold layer that includes a dielectric layer and is on the metamaterial layer.

10. The apparatus of claim 9, wherein the mold layer is an anti-reflection coating (ARC) for a frequency spectrum of an incident light, and the mold layer is configured to allow a portion of the incident light to pass to the metamaterial layer.

11. The apparatus of claim 10, wherein the mold layer is an optical filter configured to allow the portion of the incident light to pass to the metamaterial layer at a frequency range narrower than and within the frequency spectrum of the incident light.

12. The apparatus of claim 1, further comprising a substrate coupled to the base layer.

13. An optical device, comprising:
a metamaterial layer configured to absorb a portion of an incident light having a frequency spectrum, wherein the portion of the incident light has a frequency range that is narrower than and within the frequency spectrum of the incident light;
a photodiode disposed in a layer coupled to the metamaterial layer, the photodiode configured to detect an amplitude of the portion of the incident light; and
shallow trench isolation (STI) structures disposed between the metamaterial layer and the photodiode, the STI structures configured to pass the portion of the incident light within the frequency range from the metamaterial layer to the photodiode.

14. The optical device of claim 13, further comprising a mold layer coupled to the metamaterial layer, the mold layer configured to pass the portion of the incident light to the metamaterial layer.

15. The optical device of claim 13, wherein the frequency spectrum of the incident light corresponds to an infrared (IR) spectrum of light.

16. A light detector system, comprising:
a light source configured to emit a light beam having a frequency spectrum; and
a light detector configured to detect an amplitude of the light beam at the frequency spectrum, the light detector including:
a base layer comprising a photodiode and shallow trench isolation (STI) structures on the photodiode; and
a metamaterial layer on the STI structures and comprising a metasurface and a dielectric layer.

17. The light detector system of claim 16, wherein the dielectric layer is a first dielectric layer, and the light detector includes a mold layer on the metamaterial layer, the mold layer including a second dielectric layer.

18. The light detector system of claim 16, wherein the light detector is configured to determine a peak in the amplitude of the light beam.

19. The light detector system of claim 18, further comprising a chamber between the light source and the light detector, the chamber configured to contain a gas or a fluid and to allow the light beam to propagate through the chamber from the light source to the light detector.

20. The light detector system of claim 19, further comprising a processor coupled to the light detector and configured to determine a type, composition, or density of the gas or the fluid based on the peak in the amplitude of the light beam.
